(19) United States
(12) Patent Application Publication
(10) Pub. No.: US 2020/0394188 A1
(43) Pub. Date: Dec. 17, 2020

(54) GENEALOGICAL TREE TRACING AND STORY GENERATION

(71) Applicant: Ancestry.com Operations Inc., Lehi, UT (US)

(72) Inventors: Tridip Roy, San Francisco, CA (US); Chiranthan Nandalike, San Francisco, CA (US); Anne Caitlyn Selleck, San Francisco, CA (US)

(73) Assignee: Ancestry.com Operations Inc., Lehi, UT (US)

(21) Appl. No.: 16/901,950

(22) Filed: Jun. 15, 2020

Related U.S. Application Data
(60) Provisional application No. 62/862,588, filed on Jun. 17, 2019.

(51) Int. Cl. G06F 16/2458; G06F 16/22

(52) U.S. Cl. CPC G06F 16/2465; G06F 16/2246

(57) ABSTRACT

Techniques for generating genealogical stories by tracing genealogical trees are disclosed. An input tree person within a genealogical tree is identified. The genealogical tree may include a plurality of tree persons corresponding to individuals. The plurality of tree persons may be interconnected through a plurality of connections. The plurality of connections in the genealogical tree may be traced based on one or more story tracing filters to identify one or more tree persons from the plurality of tree persons that are related to the input tree person and to identify data elements associated with the one or more tree persons. The data elements associated with the one or more tree persons may be filtered based on one or more story data filters. Filtering the data elements may cause a subset of the data elements to be selected. A genealogical story may be generated by aggregating the filtered data elements.

### CROSS-REFERENCES TO RELATED APPLICATIONS

This application claims the benefit of priority to U.S. Provisional Patent Application No. 62/862,588 filed Jun. 17, 2019, entitled “PERSONALIZING AND AGGREGATING INFORMATION ABOUT A PERSON,” the contents of which are herein incorporated in their entirety.

### BACKGROUND OF THE INVENTION

In certain genealogical or family history databases, ancestor data is stored in trees which contain multiple persons or individuals. Trees may also include intra-tree relationships which indicate the relationships between the various individuals within a certain tree. In many cases, persons in one tree may correspond to persons in other trees, as users have common ancestors with other users. As such, one challenge in maintaining genealogical databases has been entity resolution, which refers to the problem of identifying and linking different manifestations of the same real-world entity. For example, many manifestations of the same person may appear across multiple trees. This problem arises due to discrepancies between different historical records, discrepancies between historical records and human accounts, and discrepancies between different human accounts. For example, different users having a common ancestor may have different opinions as to the name, date of birth, and place of birth of that ancestor. The problem becomes particularly prevalent when large amounts of historical documents are difficult to read or transcribe, causing a wide range of possible ancestor data. Accordingly, there is a need for improved techniques in the area.

When a person researches their family history using a genealogical database with records and user tree data, they often receive various ancestor data for their ancestor in raw form. For many people it is difficult to understand how this raw data translates into an ancestor's life and experience or how to connect that data to other information they have or is available the history of the time and place where that ancestor lived. The majority of people are interested in learning about their family history and the lives of their ancestors. However, very few people understand the connection between accessible family tree information, public records, and learning more about that person's life, and the historical context.

### BRIEF SUMMARY OF THE INVENTION

A brief summary of the invention is provided below in reference to a list of examples. As used below, any reference to a series of examples is to be understood as a reference to each of those examples disjunctively (e.g., “Examples 1-4” is to be understood as “Examples 1, 2, 3, or 4”).

Example 1 is a computer-implemented method comprising: identifying an input tree person within a genealogical tree, wherein the genealogical tree comprises a plurality of tree persons corresponding to individuals, wherein the plurality of tree persons are interconnected through a plurality of connections; tracing the plurality of connections in the genealogical tree based on one or more story tracing filters to identify one or more tree persons from the plurality of tree persons that are related to the input tree person and to identify data elements associated with the one or more tree persons; filtering the data elements associated with the one or more tree persons based on one or more story data filters, wherein filtering the data elements causes a subset of the data elements to be selected; and generating a genealogical story by aggregating the filtered data elements.

Example 2 is the computer-implemented method of example(s) 1, wherein the one or more story tracing filters comprise one or more of: a time period; a historical event; a cultural moment; a family event; or a behavioral trend.

Example 3 is the computer-implemented method of example(s) 1-2, wherein the one or more story data filters comprise one or more of: a desired quantity of data elements; a desired type of data elements; a desired quality of data elements; a desired relatedness of data elements; a desired historical relevance; a desired time period relevance; or a desired location relevance.

Example 4 is the computer-implemented method of example(s) 1-3, wherein the genealogical story is generated based on one or more story generation filters, wherein the one or more story generation filters comprise one or more of: a story template; a story narration setting; or a personalized story setting.

Example 5 is the computer-implemented method of example(s) 1-4, further comprising: receiving a user input indicating the input tree person.

Example 6 is the computer-implemented method of example(s) 1-5, wherein the user input further indicates the one or more story tracing filters.

Example 7 is the computer-implemented method of example(s) 1-6, wherein the user input further indicates the one or more story data filters.

Example 8 is the computer-implemented method of example(s) 1-7, wherein the input tree person is a user or an ancestor of the user.

Example 9 is a non-transitory computer-readable medium comprising instructions that, when executed by one or more processors, cause the one or more processors to perform operations comprising: identifying an input tree person within a genealogical tree, wherein the genealogical tree comprises a plurality of tree persons corresponding to individuals, wherein the plurality of tree persons are interconnected through a plurality of connections; tracing the plurality of connections in the genealogical tree based on one or more story tracing filters to identify one or more tree persons from the plurality of tree persons that are related to the input tree person and to identify data elements associated with the one or more tree persons; filtering the data elements associated with the one or more tree persons based on one or more story data filters, wherein filtering the data elements causes a subset of the data elements to be selected; and generating a genealogical story by aggregating the filtered data elements.

Example 10 is the non-transitory computer-readable medium of example(s) 9, wherein the one or more story tracing filters comprise one or more of: a time period; a historical event; a cultural moment; a family event; or a behavioral trend.

Example 11 is the non-transitory computer-readable medium of example(s) 9-10, wherein the one or more story data filters comprise one or more of: a desired quantity of data elements; a desired type of data elements; a desired quality of data elements; a desired relatedness of data elements; a desired historical relevance; a desired time period relevance; or a desired location relevance.

Example 12 is the non-transitory computer-readable medium of example(s) 9-11, wherein the genealogical story is generated based on one or more story generation filters, wherein the one or more story generation filters comprise one or more of: a story template; a story narration setting; or a personalized story setting.

Example 13 is the non-transitory computer-readable medium of example(s) 9-12, wherein the operations further comprise: receiving a user input indicating the input tree person.

Example 14 is the non-transitory computer-readable medium of example(s) 9-13, wherein the input tree person is a user or an ancestor of the user.

Example 15 is a system comprising: one or more processors; and a non-transitory computer-readable medium comprising instructions that, when executed by the one or more processors, cause the one or more processors to perform operations comprising: identifying an input tree person within a genealogical tree, wherein the genealogical tree comprises a plurality of tree persons corresponding to individuals, wherein the plurality of tree persons are interconnected through a plurality of connections; tracing the plurality of connections in the genealogical tree based on one or more story tracing filters to identify one or more tree persons from the plurality of tree persons that are related to the input tree person and to identify data elements associated with the one or more tree persons; filtering the data elements associated with the one or more tree persons based on one or more story data filters, wherein filtering the data elements causes a subset of the data elements to be selected; and generating a genealogical story by aggregating the filtered data elements.

Example 16 is the system of example(s) 15, wherein the one or more story tracing filters comprise one or more of: a time period; a historical event; a cultural moment; a family event; or a behavioral trend.

Example 17 is the system of example(s) 15-16, wherein the one or more story data filters comprise one or more of: a desired quantity of data elements; a desired type of data elements; a desired quality of data elements; a desired relatedness of data elements; a desired historical relevance; a desired time period relevance; or a desired location relevance.

Example 18 is the system of example(s) 15-17, wherein the genealogical story is generated based on one or more story generation filters, wherein the one or more story generation filters comprise one or more of: a story template; a story narration setting; or a personalized story setting.

Example 19 is the system of example(s) 15-18, wherein the operations further comprise: receiving a user input indicating the input tree person.

Example 20 is the system of example(s) 15-19, wherein the input tree person is a user or an ancestor of the user.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example tree including multiple tree persons.

FIG. 2 illustrates an example of a set of trees that may be included in a genealogical database.

FIG. 3 illustrates an example formation of a stitched tree.

FIG. 4 illustrates an example method for generating a genealogical story using data from a genealogical database.

FIGS. 5A and 5B illustrate an example performance of a method.

FIG. 6 illustrates an example computer system comprising various hardware elements.

### DESCRIPTION OF THE INVENTION

Embodiments of the present disclosure provide for systems, methods, and other techniques for automatically discovering and creating a genealogical story by tracing and filtering a genealogical tree. Embodiments include a framework and tool that enables re-creation of important events and highlights of the life of the person (e.g. an ancestor of a user) related to their educational, social, moral, religious, customary, political, economic, and occupational activities from historical records and tree content. An ancestor's life can be recreated using data about them provided by other family members or found in historical records, matched with historical research about the location and time period that person resided or visited.

As used herein, the terms “tree”, “family tree”, and “genealogical tree” may be used interchangeably and may refer to the grouping of a finite number of related persons that are interconnected according to their relationships. Two persons that are directly connected in a tree may be in a parent-child relationship, in a sibling relationship, or in some other relationship. A tree may be displayed as various points/nodes connected by lines. The base or bottom of the tree may comprise a single individual, which may or may not be a user of the tree.

As used herein, the terms “tree person”, “person”, “individual”, and “node” may be used interchangeably and may refer to a representation in a tree of a living or deceased real-life individual.

As used herein, the term “user” may refer to an owner or creator of a tree, or may refer to any entity, human or non-human, that is using a tree or genealogical database in some manner.

As used herein, the term “cluster” may refer to a grouping of tree persons, each from different trees and each determined to correspond to the same real-life individual. Although clusters are designed to group only tree persons that correspond to the same real-life individual, this is not always possible, and often clusters are either overinclusive or underinclusive based on the similarity threshold that is employed.

Embodiments of the present invention are illustrated in the attached drawings. For example, various methods are illustrated in the attached drawings. Each of the methods are illustrated as comprising various steps. One or more of the illustrated steps need not be performed in the illustrated order. Furthermore, one or more of the illustrated steps may be omitted during performance of the corresponding method.

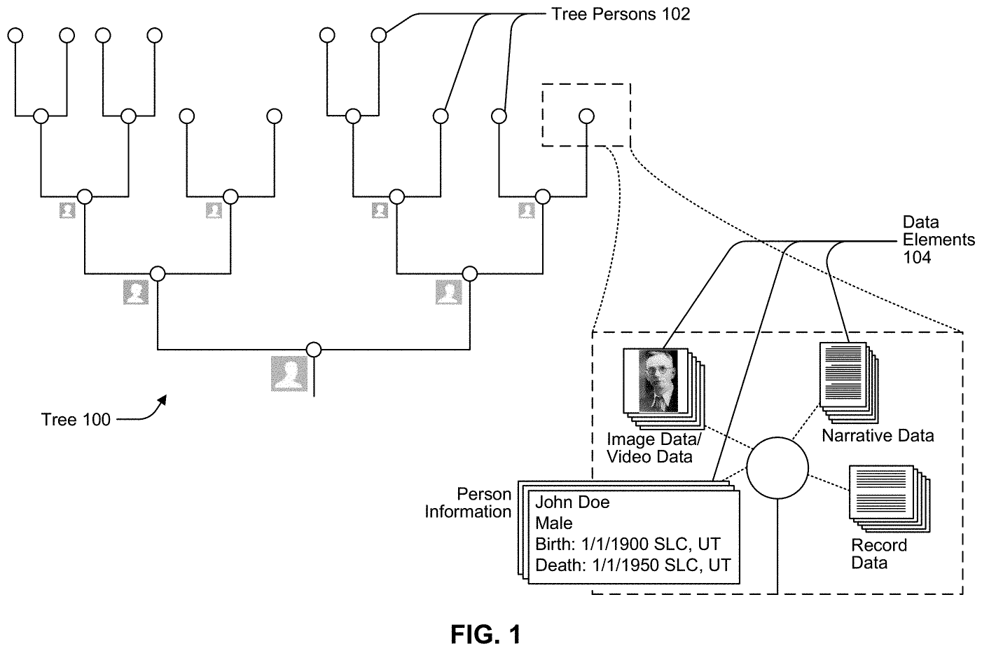

FIG. 1 illustrates an example tree 100 including multiple tree persons 102, according to some embodiments of the present disclosure. Tree 100 may have features that are similar to a conventional family tree or pedigree chart, which show family relationships in a tree structure, with older generations toward the top of the tree and newer generations toward the bottom of the tree. Tree 100 may further include various data elements 104 that are associated with tree persons 102. For example, tree 100 may include a different set of data elements 104 for each of tree persons 102.

In the illustrated example, data elements 104 include image data (e.g., images associated with the corresponding tree person), video data (e.g., video associated with the corresponding tree person), narrative data (e.g., spoken or written accounts associated with the corresponding tree person), record data (e.g., records associated with the corresponding tree person such as birth certificates, marriage certificates, etc.), and person information (e.g., the corresponding tree person's name, gender, date of birth, place of birth, date of death, place of death, etc.). Data elements 104 may be discoverable by a user of a genealogical database by, for example, selecting one of tree persons 102 and viewing or downloading any associated data elements 104. The user may also add one or more new data elements 104 to one of tree persons 102 by selecting the tree person and entering or uploading the new data elements 104. Such added data elements 104 may then be discoverable by another user of tree 100.

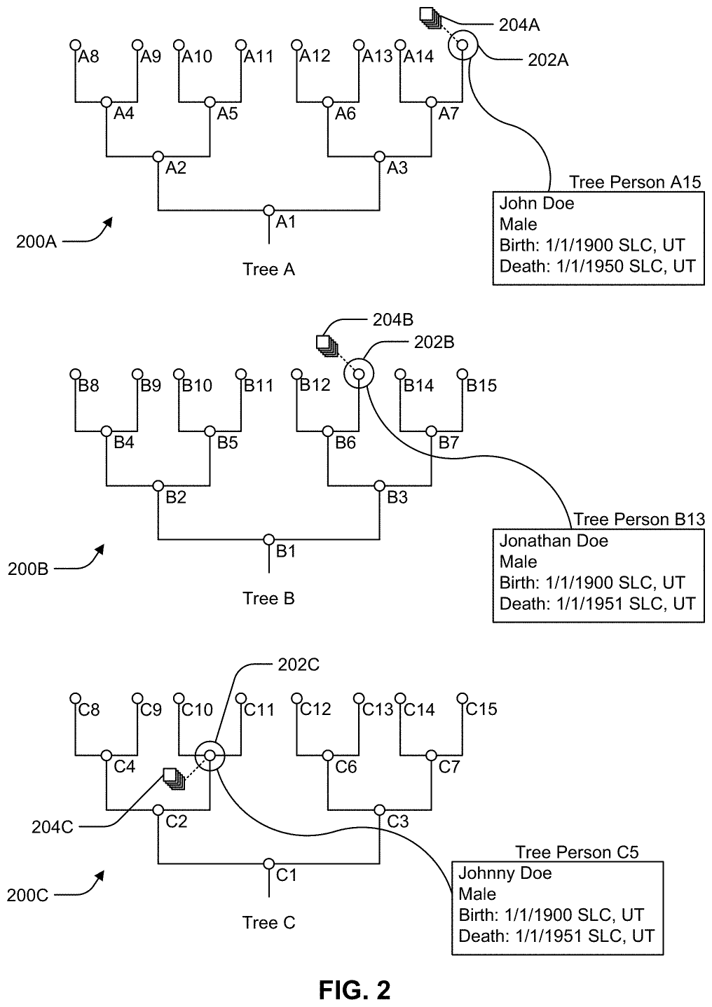

FIG. 2 illustrates an example of a set of trees 200 that may be included in a genealogical database, according to some embodiments of the present disclosure. Trees 200 includes trees 200A, 200B, and 200C, which are also denoted as Trees A, B, and C, respectively. Trees A, B, and C may be owned, created, and/or used by Tree Persons A1, B1, and C1, or by some other users unrelated to persons in Trees A, B, and C. In some embodiments, it may be determined that tree persons 202 correspond to the same real-life individual, for example, based on the similarity of their associated data elements 204. Specifically, it may be determined that tree person 202A in tree 200A, which is also denoted as Tree Person A15 (named “John Doe”), tree person 202B in tree 200B, which is also denoted as Tree Person B13 (named “Jonathan Doe”), and tree person 202C in tree 200C, which is also denoted as Tree Person C5 (named “Johnny Doe”) correspond to the same real-life individual based on their similarity.

By grouping or linking Tree Persons A15, B13, and C5, data elements 204 associated with tree persons 202 can be discoverable by users of any of trees 200. Thus, users of any of trees 200 can be benefitted by the additional information associated with their ancestor. For example, although a user of Tree A may understand Tree Person A15 to be John Doe, it may be beneficial to that user to become aware of the information discovered by the users of Trees B and C, who understand John Doe to have a differently spelled name and a different date of death. Similarly, users of Trees B and C may benefit to know of alternate spellings and dates of death for Tree Persons B13 and C5, whom they understand to be Jonathan Doe and Johnny Doe, respectively. Therefore, to assist users of Trees A, B, and C in their genealogical research, it is often advantageous to identify, group, and possibly merge together tree persons that are determined to correspond to the same real-life individual. In some instances, the grouping of Tree Persons A15, B13, and C5 is referred to as a cluster.

One method for determining whether Tree Persons A15, B13, and C5 correspond to the same real-life individual is a rule-based algorithm in which a human expert looks at different pairs of persons and creates rules. For example, consider that two persons are named “Jack Smith” but one is born in Mar. 1, 1981 and the other is born in Mar. 1, 1932. A rule-based algorithm may generate four separate scores, one for a comparison of the names (a high score in this example), one for a comparison of the month of birth (a high score in this example), one for a comparison of the day of birth (a high score in this example), and one for the year of birth (a low score in this example). The four separate scores are added together to generate a final similarity score. Only if the similarity score exceeds a threshold are the two tree persons determined to correspond to the same real-life individual.

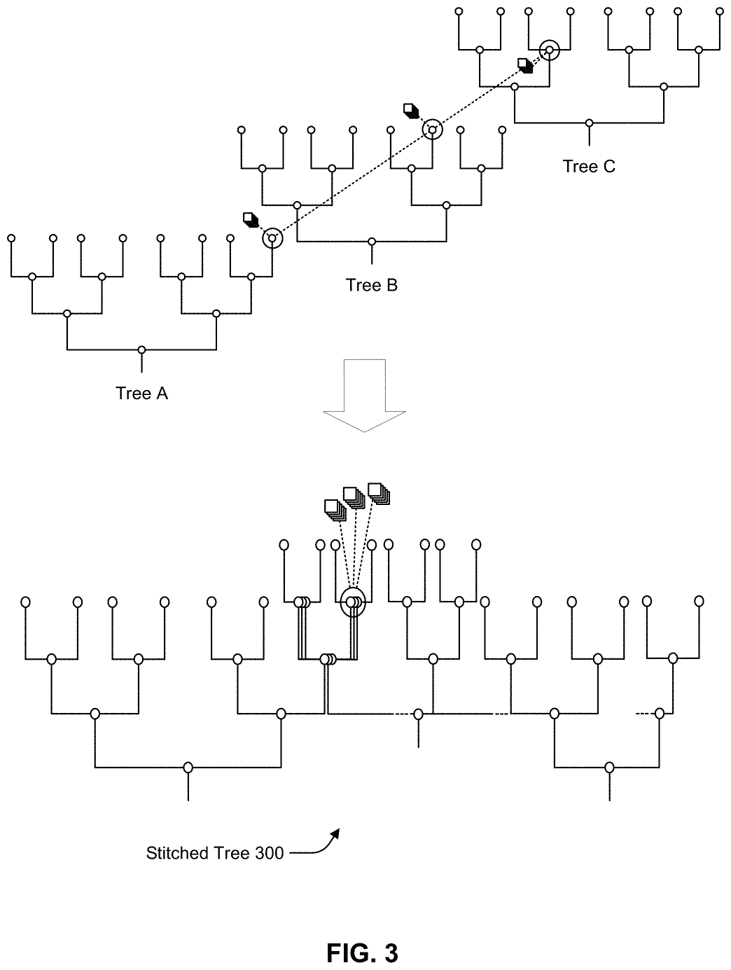

FIG. 3 illustrates an example formation of a stitched tree 300, according to some embodiments of the present disclosure. In the illustrated example, Trees A, B, and C are “stitched” together at each identified cluster to form stitched tree 300. For example, Trees A, B, and C may be stitched together at the cluster formed by Tree Persons A15, B13, and C5. The cluster may form a node of stitched tree 300 and the data elements for each of the tree persons in the cluster may all be associated with the node (or aggregate tree person) in stitched tree 300. Accordingly, a user of stitched tree 300 may select the aggregate tree person at the node/cluster formed by Tree Persons A15, B13, and C5 and discover the associated data elements. Trees A, B, and C may be further stitched together at other identified clusters, such as the son or wife of Tree Persons A15, B13, and C5.

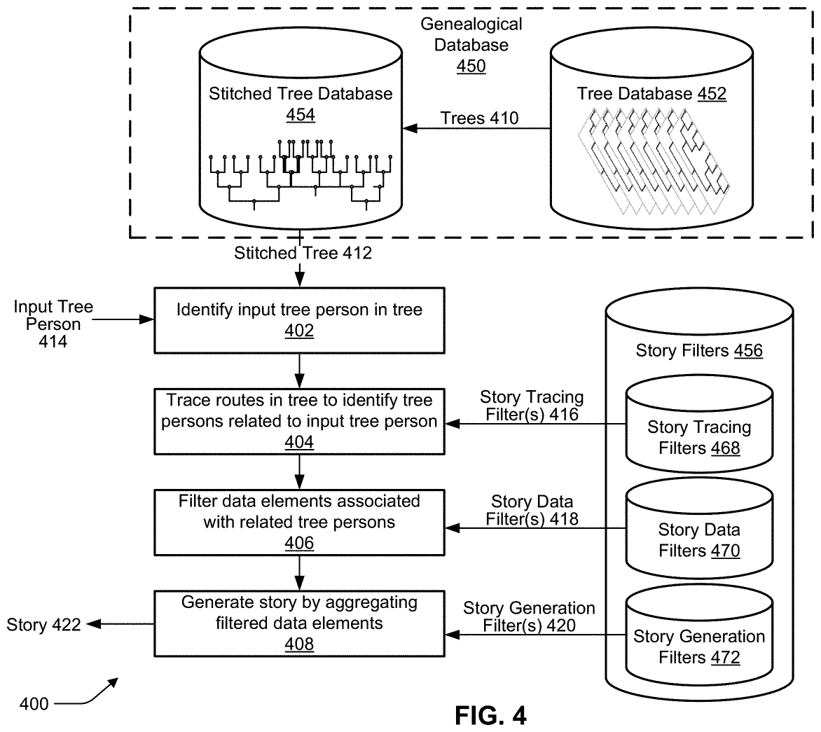

FIG. 4 illustrates an example method 400 for generating a genealogical story 422 using data from a genealogical database 450, according to some embodiments of the present disclosure. One or more steps of method 400 may be omitted during performance of method 400, and steps of method 400 need not be performed in the order shown. One or more steps of method 400 may be performed by one or more processors. Method 400 may be implemented as a computer-readable medium or computer program product comprising instructions which, when the program is executed by one or more computers, cause the one or more computers to carry out the steps of method 400. Such computer program products can be transmitted, over a wired or wireless network, in a data carrier signal carrying the computer program product.

At step 402, an input tree person 414 is identified within a genealogical tree. In some embodiments, the genealogical tree may be stored in and retrieved from genealogical database 450. In some embodiments, genealogical database 450 may include a tree database 452 comprising a plurality of genealogical trees 410. Genealogical database 450 may also include a stitched tree database 454 comprising a stitched tree 412 formed by stitching together genealogical trees 410. In various embodiments, input tree person 414 may be identified within stitched tree 412 or within one of genealogical trees 410.

In some embodiments, step 402 may include receiving a user input indicating input tree person 414. For example, a user may indicate input tree person 414 by providing their name (e.g., by typing the name of the user using a keyboard) or by indicating a tree person within the genealogical tree by selecting the tree person with a mouse, typing the name or other identifier for the tree person, speaking the name for the tree person into a microphone, among other possibilities.

At step 404, the plurality of connections in the genealogical tree are traced based on one or more story tracing filters 416 to identify one or more tree persons that are related to input tree person 414 and to identify data elements associated with the one or more tree persons. Story tracing filters 416 may include rules for tracing the plurality of connections, such as a minimum number of generations (or levels) away from input tree person 414, a maximum number of generations away from input tree person 414, a minimum or maximum number of hops in the paternal direction of the genealogical tree, a minimum or maximum number of hops in the maternal direction of the genealogical tree, among other possibilities. Story tracing filters 416 may include certain criteria for identifying the one or more tree persons, such as a time period, a historical event, a cultural moment, a family event, or a behavioral trend, among other possibilities. Examples of family events may include a first person in a portion of the genealogical tree to attend college, to vote, to live in a particular city, to be in an interracial marriage, among other possibilities. Examples of behavior trends may include a portion of the genealogical tree that is blue-collar, is renters, is farmers, among other possibilities.

Upon identifying the one or more tree persons, the data elements associated with the one or more tree persons may also be identified. In some embodiments, if any of the one or more tree persons is an aggregate tree person belonging to a cluster, all of the data elements associated with the aggregate tree person may be identified. In some embodiments, the identified data elements may be retrieved, copied, or downloaded from genealogical database 450 so that they can be further processed by the one or more processors performing method 400.

In some embodiments, step 404 may also include receiving story tracing filters 416, which may be received from a set of story filters 456. In some embodiments, story tracing filters 416 may be selected from a set of story tracing filters 468. For example, in some embodiments the user may manually select story tracing filters 416 upon reviewing the set of story tracing filters 468. In some embodiments, story tracing filters 416 may be automatically selected from the set of story tracing filters 468 by the one or more processors performing method 400.

At step 406, the data elements associated with the one or more tree persons are filtered based on one or more story data filters 418. Filtering the data elements associated with the one or more tree persons may cause a subset of the data elements to be selected and the remaining elements to not be selected. Data elements that are not selected may be deleted or removed. Story data filters 418 may include a desired quantity of data elements, a desired type of data elements, a desired quality of data elements, a desired relatedness of data elements, a desired historical relevance, a desired time period relevance, or a desired location relevance, among other possibilities.

In some embodiments, step 406 may also include receiving story data filters 418, which may be received from the set of story filters 456. In some embodiments, story data filters 418 may be selected from a set of story data filters 470. For example, in some embodiments the user may manually select story data filters 418 upon reviewing the set of story data filters 470. In some embodiments, story data filters 418 may be automatically selected from the set of story data filters 470 by the one or more processors performing method 400.

At step 408, genealogical story 422 is generated by aggregating the filtered data elements. In some embodiments, genealogical story 422 is generated based on one or more story generation filters 420. For example, story generation filters 420 may include rules for ordering and aggregating the filtered data elements, such as through a story template. In one example, a story generation filter may provide a framework for arranging image data alongside narrative data. In another example, a story generation filter may cause text to be generated in a manner that describes each data element and connects the descriptions between different data elements. In various embodiments, story generation filters 420 may include a story template, a story narration setting, or a personalized story setting, among other possibilities.

In some embodiments, step 408 may also include receiving story generation filters 420, which may be received from the set of story filters 456. In some embodiments, story generation filters 420 may be selected from a set of story generation filters 472. For example, in some embodiments the user may manually select story generation filters 420 upon reviewing the set of story generation filters 472. In some embodiments, story generation filters 420 may be automatically selected from the set of story generation filters 472 by the one or more processors performing method 400.

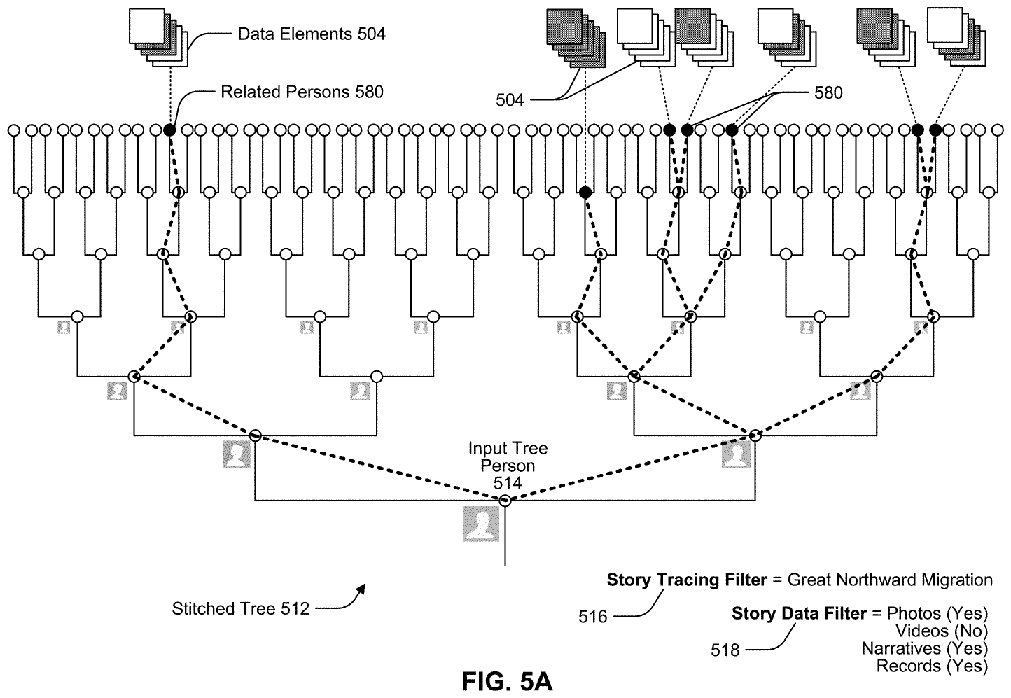

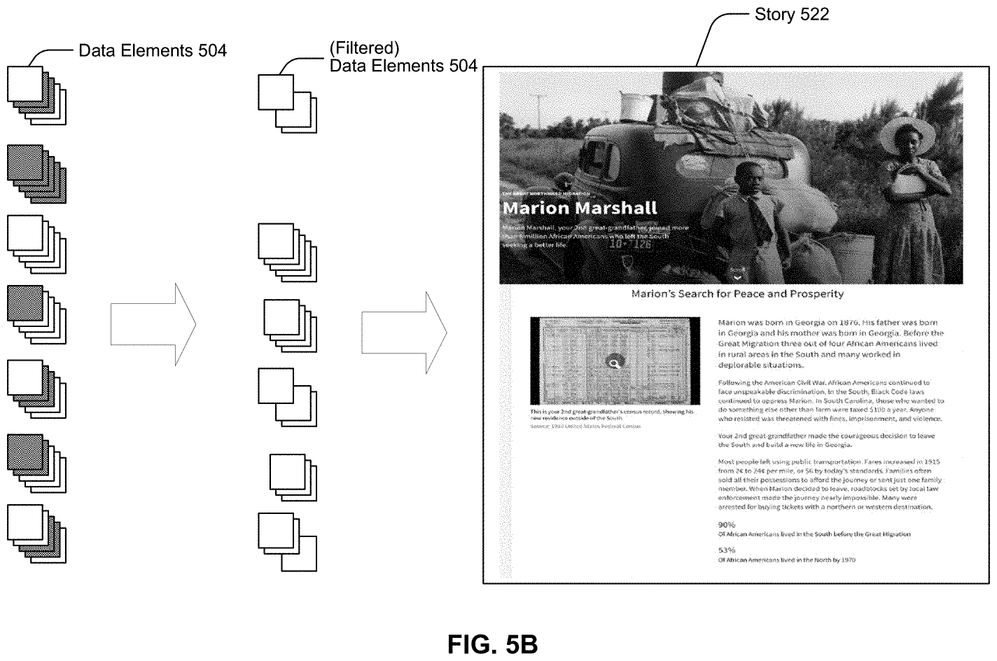

FIGS. 5A and 5B illustrate an example performance of method 400, according to some embodiments of the present disclosure. In reference to FIG. 5A, an input tree person 514 is identified within a genealogical tree, which is stitched tree 512. Next, the connections of the genealogical tree are traced based on a story tracing filter 516 (specifying the Great Northward Migration) to identify related persons 580 and data elements 504 associated with related persons 580. Data elements 504 are then filtered based on a story data filter 518 (specifying photos, stories, and narratives and excluding videos), as illustrated by the darkened shading of certain data elements of data elements 504.

In reference to FIG. 5B, the step of filtering data elements 504 is illustrated by the removal of data elements that are not consistent with story data filter 518. A genealogical story 522 is then generated by aggregating the filtered data elements 504 in the manner shown.

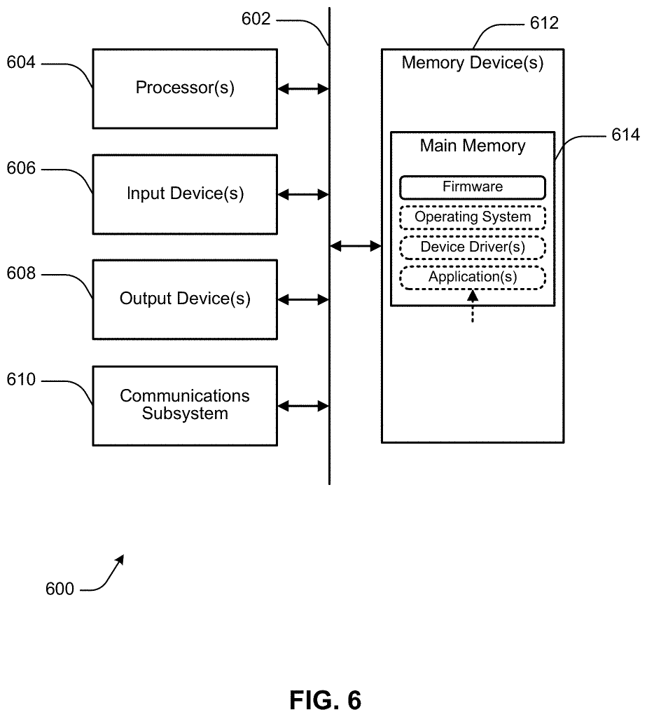

FIG. 6 illustrates an example computer system 600 comprising various hardware elements, according to some embodiments of the present disclosure. Computer system 600 may be incorporated into or integrated with devices described herein and/or may be configured to perform some or all of the steps of the methods provided by various embodiments. For example, in various embodiments, computer system 600 may be configured to perform method 400. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

In the illustrated example, computer system 600 includes a communication medium 602, one or more processor(s) 604, one or more input device 606, one or more output devices 608, a communications subsystem 610, and one or more memory device(s) 612. Computer system 600 may be implemented using various hardware implementations and embedded system technologies. For example, one or more elements of computer system 600 may implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device such as an SoC FPGA, among other possibilities.

The various hardware elements of computer system 600 may be coupled via communication medium 602. While communication medium 602 is illustrated as a single connection for purposes of clarity, it should be understood that communication medium 602 may include various numbers and types of communication media for transferring data between hardware elements. For example, communication medium 602 may include one or more wires (e.g., conductive traces, paths, or leads on a printed circuit board (PCB) or integrated circuit (IC), microstrips, striplines, coaxial cables, etc.), one or more optical waveguides (e.g., optical fibers, strip waveguides, etc.), one or more wireless connections (e.g., infrared wireless communication, radio communication, microwave wireless communication, etc.), among other possibilities.

In some embodiments, communication medium 602 may include one or more buses connecting pins of the hardware elements of computer system 600. For example, communication medium 602 may include a bus connecting processor(s) 604 with main memory 614, referred to as a system bus, and a bus connecting main memory 614 with input device(s) 606 or output device(s) 608, referred to as an expansion bus. The system bus may consist of several elements, including an address bus, a data bus, and a control bus. The address bus may carry a memory address from processor(s) 604 to the address bus circuitry associated with main memory 614 in order for the data bus to access and carry the data contained at the memory address back to processor(s) 604. The control bus may carry commands from processor(s) 604 and return status signals from main memory 614. Each bus may include multiple wires for carrying multiple bits of information and each bus may support serial or parallel transmission of data.

Processor(s) 604 may include one or more central processing units (CPUs), graphics processing units (GPUs), neural network processors or accelerators, digital signal processors (DSPs), and/or the like. A CPU may take the form of a microprocessor, which is fabricated on a single IC chip of metal-oxide-semiconductor field-effect transistor (MOSFET) construction. Processor(s) 604 may include one or more multi-core processors, in which each core may read and execute program instructions simultaneously with the other cores.

Input device(s) 606 may include one or more of various user input devices such as a mouse, a keyboard, a microphone, etc., as well as various sensor input devices, such as an image capture device, a pressure sensor (e.g., barometer, tactile sensor, etc.), a temperature sensor (e.g., thermometer, thermocouple, thermistor, etc.), a movement sensor (e.g., accelerometer, gyroscope, tilt sensor, etc.), a light sensor (e.g., photodiode, photodetector, charge-coupled device, etc.). Output device(s) 608 may include one or more of various devices that convert information into human-readable form, such as without limitation a display device, a speaker, a printer, and/or the like.

Communications subsystem 610 may include hardware components for connecting computer system 600 to systems or devices that are located external computer system 600, such as over a computer network. In various embodiments, communications subsystem 610 may include a wired communication device coupled to one or more input/output ports (e.g., a universal asynchronous receiver-transmitter (UART), etc.), an optical communication device (e.g., an optical modem, etc.), an infrared communication device, a radio communication device (e.g., a wireless network interface controller, a BLUETOOTH® device, an IEEE 802.11 device, a Wi-Fi device, a Wi-Max device, a cellular device, etc.), among other possibilities.

Memory device(s) 612 may include the various data storage devices of computer system 600. For example, memory device(s) 612 may include various types of computer memory with various response times and capacities, from faster response times and lower capacity memory, such as processor registers and caches (e.g., L0, L1, L2, etc.), to medium response time and medium capacity memory, such as random access memory, to lower response times and lower capacity memory, such as solid state drives and hard drive disks. While processor(s) 604 and memory device(s) 612 are illustrated as being separate elements, it should be understood that processor(s) 604 may include varying levels of on-processor memory such as processor registers and caches that may be utilized by a single processor or shared between multiple processors.

Memory device(s) 612 may include main memory 614, which may be directly accessible by processor(s) 604 via the memory bus of communication medium 602. For example, processor(s) 604 may continuously read and execute instructions stored in main memory 614. As such, various software elements may be loaded into main memory 614 to be read and executed by processor(s) 604 as illustrated in FIG. 6. Typically, main memory 614 is volatile memory, which loses all data when power is turned off and accordingly needs power to preserve stored data. Main memory 614 may further include a small portion of non-volatile memory containing software (e.g., firmware, such as BIOS) that is used for reading other software stored in memory device(s) 612 into main memory 614. In some embodiments, the volatile memory of main memory 614 is implemented as random-access memory (RAM), such as dynamic RAM (DRAM), and the non-volatile memory of main memory 614 is implemented as read-only memory (ROM), such as flash memory, erasable programmable read-only memory (EPROM), or electrically erasable programmable read-only memory (EEPROM).

Computer system 600 may include software elements, shown as being currently located within main memory 614, including an operating system, device driver(s), firmware, compilers, and/or other code, such as one or more application programs, which may include computer programs provided by various embodiments of the present disclosure. Merely by way of example, one or more steps described with respect to any methods discussed above, might be implemented as code and/or instructions executable by computer system 600. For example, such code and/or instructions may be received by computer system 600 using communications subsystem 610, carried by communication medium 602 to memory device(s) 612, stored within memory device(s) 612, read into main memory 614, and executed by processor(s) 604 in accordance with the described methods.

In some embodiments, a set of these instructions and/or code may be stored on a non-transitory computer-readable storage medium, such as memory device(s) 612, as described above. In some cases, the non-transitory computer-readable storage medium might be incorporated within computer system 600. In other embodiments, the non-transitory computer-readable storage medium might be separate from computer system 600 e.g., a removable medium, such as a flash memory card, a Universal Serial Bus (USB) flash drive, a Secure Digital (SD) card, an optical disc, a floppy disk, an external hard disk drive, any memory chip, cartridge, or any other medium from which a computer can read instructions and/or code, and/or provided in an installation package, such that the storage medium can be used to program, configure, and/or adapt computer system 600 with the instructions/code stored thereon. These instructions might take the form of executable code, which is executable by computer system 600 and/or might take the form of source and/or installable code, which, upon compilation and/or installation on computer system 600 e.g., using any of a variety of generally available compilers, installation programs, compression/decompression utilities, etc., then takes the form of executable code.

As mentioned above, some embodiments may employ a system such as computer system 600 to perform methods in accordance with various embodiments of the present disclosure. For example, some embodiments may include a system comprising one or more processors, such as processor(s) 604, that are communicatively coupled to a non-transitory computer-readable storage medium, such as main memory 614. The non-transitory computer-readable storage medium may include instructions that, when executed by the one or more processors, cause the one or more processors to perform the methods described in the various embodiments.

The terms “machine-readable medium”, “machine-readable storage medium”, computer-readable medium”, and “computer-readable storage medium,” as used herein, refer to any medium that participates in providing data that causes a machine to operate in a specific fashion. In an embodiment implemented using computer system 600, various computer-readable media might be involved in providing instructions/code to processor(s) 604 for execution and/or might be used to store and/or carry such instructions/code. In many implementations, a computer-readable medium is a physical and/or tangible storage medium. Such a medium may take the form of a non-volatile medium or volatile medium.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes one or more of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A computer-implemented method comprising:
identifying an input tree person within a genealogical tree, wherein the genealogical tree comprises a plurality of tree persons corresponding to individuals, wherein the plurality of tree persons are interconnected through a plurality of connections;
tracing the plurality of connections in the genealogical tree based on one or more story tracing filters to identify one or more tree persons from the plurality of tree persons that are related to the input tree person and to identify data elements associated with the one or more tree persons;
filtering the data elements associated with the one or more tree persons based on one or more story data filters, wherein filtering the data elements causes a subset of the data elements to be selected; and
generating a genealogical story by aggregating the filtered data elements.

2. The computer-implemented method of claim 1, wherein the one or more story tracing filters comprise one or more of:
a time period;
a historical event;
a cultural moment;
a family event; or
a behavioral trend.

3. The computer-implemented method of claim 1, wherein the one or more story data filters comprise one or more of:
a desired quantity of data elements;
a desired type of data elements;
a desired quality of data elements;
a desired relatedness of data elements;
a desired historical relevance;
a desired time period relevance; or
a desired location relevance.

4. The computer-implemented method of claim 1, wherein the genealogical story is generated based on one or more story generation filters, wherein the one or more story generation filters comprise one or more of:
a story template;
a story narration setting; or
a personalized story setting.

5. The computer-implemented method of claim 1, further comprising:
receiving a user input indicating the input tree person.

6. The computer-implemented method of claim 5, wherein the user input further indicates the one or more story tracing filters.

7. The computer-implemented method of claim 5, wherein the user input further indicates the one or more story data filters.

8. The computer-implemented method of claim 1, wherein the input tree person is a user or an ancestor of the user.

9. A non-transitory computer-readable medium comprising instructions that, when executed by one or more processors, cause the one or more processors to perform operations comprising:
identifying an input tree person within a genealogical tree, wherein the genealogical tree comprises a plurality of tree persons corresponding to individuals, wherein the plurality of tree persons are interconnected through a plurality of connections;
tracing the plurality of connections in the genealogical tree based on one or more story tracing filters to identify one or more tree persons from the plurality of tree persons that are related to the input tree person and to identify data elements associated with the one or more tree persons;
filtering the data elements associated with the one or more tree persons based on one or more story data filters, wherein filtering the data elements causes a subset of the data elements to be selected; and
generating a genealogical story by aggregating the filtered data elements.

10. The non-transitory computer-readable medium of claim 9, wherein the one or more story tracing filters comprise one or more of:
a time period;
a historical event;
a cultural moment;
a family event; or
a behavioral trend.

11. The non-transitory computer-readable medium of claim 9, wherein the one or more story data filters comprise one or more of:
a desired quantity of data elements;
a desired type of data elements;
a desired quality of data elements;
a desired relatedness of data elements;
a desired historical relevance;
a desired time period relevance; or
a desired location relevance.

12. The non-transitory computer-readable medium of claim 9, wherein the genealogical story is generated based on one or more story generation filters, wherein the one or more story generation filters comprise one or more of:
a story template;
a story narration setting; or
a personalized story setting.

13. The non-transitory computer-readable medium of claim 9, wherein the operations further comprise:
receiving a user input indicating the input tree person.

14. The non-transitory computer-readable medium of claim 9, wherein the input tree person is a user or an ancestor of the user.

15. A system comprising:
one or more processors; and
a non-transitory computer-readable medium comprising instructions that, when executed by the one or more processors, cause the one or more processors to perform operations comprising:
identifying an input tree person within a genealogical tree, wherein the genealogical tree comprises a plurality of tree persons corresponding to individuals, wherein the plurality of tree persons are interconnected through a plurality of connections;
tracing the plurality of connections in the genealogical tree based on one or more story tracing filters to identify one or more tree persons from the plurality of tree persons that are related to the input tree person and to identify data elements associated with the one or more tree persons;
filtering the data elements associated with the one or more tree persons based on one or more story data filters, wherein filtering the data elements causes a subset of the data elements to be selected; and
generating a genealogical story by aggregating the filtered data elements.

16. The system of claim 15, wherein the one or more story tracing filters comprise one or more of:
a time period;
a historical event;
a cultural moment;
a family event; or
a behavioral trend.

17. The system of claim 15, wherein the one or more story data filters comprise one or more of:
a desired quantity of data elements;
a desired type of data elements;
a desired quality of data elements;
a desired relatedness of data elements;
a desired historical relevance;
a desired time period relevance; or
a desired location relevance.

18. The system of claim 15, wherein the genealogical story is generated based on one or more story generation filters, wherein the one or more story generation filters comprise one or more of:
a story template;
a story narration setting; or
a personalized story setting.

19. The system of claim 15, wherein the operations further comprise:
receiving a user input indicating the input tree person.

20. The system of claim 15, wherein the input tree person is a user or an ancestor of the user.
